(19) United States
(12) Patent Application Publication
(10) Pub. No.: US 2005/0055264 A1
(43) Pub. Date: Mar. 10, 2005

(54) Method and system for recruiting for, organizing, and managing a volunteer group program

(76) Inventors: Joseph Brian Gallick, Pleasantville, NY (US); Janies R. Gallick, Pleasantville, NY (US)

Correspondence Address: Abelman, Frayne & Schwab, 150 East 42nd Street, New York, NY, 10017, US

(21) Appl. No.: 10/655,864

(22) Filed: Sep. 5, 2003

(51) Int. Cl. G06F 17/60

(52) U.S. Cl. 705/9

(57) ABSTRACT

A method and system operate for recruiting participants, and organizing and managing a volunteer group program. The system is computer-based, and presents a menu of possible goals for the volunteer group program. Based on user input, the system generates an electronic organizational framework with specific roles, responsibilities, and sub-systems needed to achieve the stated goals. The system requests contact information for individuals who will take on specific responsibilities, along with information related to the specific preferences regarding ways to achieve program goals. The system generates an electronic operational manual for the volunteer group, along with appropriate tools for enlisting additional volunteer contributions and for managing their efforts. Tools may include a Web site, an automated telephone system, or other mechanisms for discussion, scheduling of services, and communication of program goals and status, and reminders to individual volunteers of pending tasks associated with the program.

### FIELD OF THE INVENTION

This invention relates to a computer-based method and system for initiating and managing a volunteer group program, and more particularly, to a method and system for establishing program goals, recruiting volunteer managers, obtaining specific information, organizing the volunteer managers to perform predetermined functions and tasks, directing the managers' and other volunteers' efforts toward specific tasks, and managing the volunteer group program throughout its lifecycle.

### BACKGROUND OF THE INVENTION

Philanthropic organizations, community groups and other social units frequently organize temporary volunteer teams around specific time-sensitive challenges. These challenges are typically in support of an individual or group, hereafter referred to as a Program Subject. An example of a Program Subject might be a family in which the primary wage earner became disabled or too sick to work. Other examples include, but are not limited to, individuals suffering physical limitations or disabilities resulting from accidents, families coping with the arrival of a new baby, families suffering a financial setback, individuals faced with the need to care for an elderly relative, a group traveling together that suffers a misfortune resulting in injury or financial loss, or individuals who are called to fulfill a responsibility that breaks their existing links to informal support networks, such as being called to active military service, attending school away from home, or being given a business assignment out of town or overseas. The temporary volunteer team that seeks to support these Program Subjects must quickly develop an organizational structure, assign roles and responsibilities, develop a list of specific tasks, analyze the challenge, schedule meetings, insure the timely completion of tasks and evaluate the team's progress.

A great deal of volunteer team time can be wasted on basic organizational development or management tasks which require skills other than the skills needed to develop a response to the original challenge. While written guidance is available and professional consultants can advise these teams on how to structure and manage their work, this leaves the original challenge unaddressed while the organizational stage is completed. Additionally, there is opportunity for overlooking tasks, roles, dates and communication steps as the team's skills are developed. Finally, it may be that some or all team members lack the natural inclination for this type of organizational development activity and, despite the competence they may bring to meeting the original challenge, are discouraged from participating by the organizational hurdle presented.

Systems and methods have been developed to make teams productive. These currently fall into two broad categories: those designed for the completion of a specialized initiative such as the development of software, and those designed for broad flexibility across a range of project types, usually focused on large-scale initiatives. The prior art systems assume that projects are staffed with employees, contractors or consultants who bring much basic knowledge to the tasks that they will undertake. Consequently, these systems and methods do not include business rules or the level of detailed guidance often needed by volunteer team members who may have limited experience in the identification, prioritization, coordination and timely completion of tasks within a team setting. The existing systems, instead, are focused on managing resources efficiently, documenting the project scope, identifying milestones and dependencies between tasks, tracking progress and status and predicting time to completion.

Systems for the management of volunteer organizations and non-for-profit organizations are known, but these systems are focused on managing fundraising, managing events, managing membership or managing the business activities of the organization itself, either at the local level, such as through the Internet at committeeonline.com, or at the national level. Other systems, such as through the Internet at eteambuilder.org or communityzero.com, offer rich feature sets, but lack rules and detail on precise activities, roles and responsibilities within volunteer programs with specific goals.

It is therefore an object of the present invention is to construct and publish a Web site or a similar communication mechanism, on a public or private network, that reflects the goals of the volunteer group program. The communication mechanism can then be accessed by non-team members, providing a means for the non-team members to volunteer for specific types of contributions that are necessary to achieve the specific goals that have been identified through the activity of the present invention. The communication mechanism integrates subsystems including a calendar for listing the opportunities to contribute by date and displaying commitments by volunteers, and a guest book that enables visitors to the Web site or other communication mechanism to provide comments to the Program Subject or other involved parties.

Another object of the present invention is to provide a method for editing the contents of the communication mechanism, such as the Web site, for corrections, for the publishing of new information, or for addressing a change in the goals of the volunteer group program.

### SUMMARY OF THE INVENTION

The above objects and other advantages are provided by the present invention, which includes a method of programming a computer system for initiating and managing a volunteer group program, the method comprising:
providing a menu of predetermined program goals to the volunteer team members through a computer system;
providing a process to the volunteer team members through a computer system for facilitating their decision as to which of the program goals to pursue;
generating and outputting electronically, from a computer system, an organizational framework based on the selected goals, with specific roles, responsibilities and features needed to achieve the decided goals;
providing tools for:
   recruiting additional volunteers;
   managing and scheduling the efforts of the additional volunteers; and
   communicating details related to progress of the volunteer group program to all interested parties;
optionally, providing to the Program Manager the opportunity of requiring a password to control access of others to the Web site or other communication mechanism through a computer system;
providing project timelines, procedures, content guidelines, examples and editable copy from a computer system for use by the additional volunteer managers; and
providing promotional materials generated by a computer system to build awareness of the volunteer group program among potential new volunteers.

In one embodiment, the tools are provided for use through a Web site accessible through a computer system with access to the Internet or a suitable private network. Alternatively, the tools are provided for use through a telephone system employing voice and keypad interactivity.

The method and system of the invention provides for recruiting participants and organizing and managing a volunteer group program. The system is computer-based, and presents a menu of possible goals for the volunteer group program. Based on user input, the system generates an electronic organizational framework with specific roles, responsibilities and sub-systems needed to achieve the stated goals.

The system requires entry of certain data into a database accessed over the Internet or residing on a suitable private network, including contact information for volunteer managers who will take on specific responsibilities, along with information related to the specific preferences regarding ways to achieve program goals. The system then generates an electronic operational manual for the volunteer manager group, along with appropriate tools for enlisting additional volunteer contributions and for managing their efforts. Tools may include a Web site, an automated telephone system and other means of communication, scheduling of services and publishing of program goals and status, as well as providing reminders to individual volunteers of pending tasks associated with the program.

Upon gaining access, a team member can add, delete or edit information that describes the goals of the program or information that has been provided by other team members.

In view of the above, the present invention has the advantage of providing a fully-integrated system and method for creating a comprehensive program that enables a volunteer team to efficiently accomplish their goals.

An advantage of the present invention is that it includes a subsystem for authentication of volunteer managers prior to allowing access to business rules or editing tools.

An additional advantage of the present invention is that it enables the volunteer managers to determine and document the specific goals of the volunteer group program.

A further advantage of the present invention is that it provides details on the roles and responsibilities that must be fulfilled by team members to achieve the specific goals of the volunteer group program.

The present invention is also advantageous because it provides guidance on the identification, recruitment, assignment, and management of additional team members needed to accomplish the specific goals of the volunteer group program.

Another advantage of the present invention is that it provides a detailed project plan based on the goals of the volunteer group program, including: specific tasks by role, when the tasks need to be completed, and known dependencies that can influence this timing.

Another advantage of the present invention is that it provides notification to the responsible volunteers, at certain intervals, of tasks that have not been completed on a timely basis, and notifies the overall Program Manager if the tasks remain uncompleted after a certain time.

Yet another advantage of the present invention is that it identifies specific information that must be shared within the team at specific points in the life of the volunteer group program.

As used herein, the following terms will be understood to have the meanings indicated. The term “customer” means the person/entity who has paid or otherwise arranged for access to the present invention and its customized program. The term “Program Subject” means the individual or group that the program is initiated to support. The term “caregiver” means the person or persons who are most directly involved with supporting the individual or group. In the case of a married couple, this would usually be the spouse. The term “manager” is a volunteer team member who usually takes on multiple roles and responsibilities, as described by the system, of the invention. These roles are clearly-defined areas of responsibility, and because they are clearly defined and the volunteer manager is provided with detailed procedural directions by the system of the invention, a volunteer manager can usually assume several roles in the program. The term “Program Manager” means the first manager identified, who has responsibilities for managing the overall progress of the program. A “volunteer” is anyone who contributes time, services, or the like to the support of the Program Subject, either as a manager, donator of goods or services, or simply as a Web site visitor who leaves a message of encouragement on the site's message board.

### BRIEF DESCRIPTION OF THE DRAWINGS

Preferred embodiments of the invention are described hereinbelow with reference to the drawings wherein:

FIG. 1 is a diagram of a computer system for implementing the present invention;

FIG. 2 is a flowchart of the method of the present invention;

FIG. 3 is a flowchart of an authentication step used in the present invention;

FIG. 4 is a flowchart of a volunteer group program management step used in the present invention; and

FIG. 5 is a flowchart of task monitoring and alerts used in the present invention.

### DETAILED DESCRIPTION

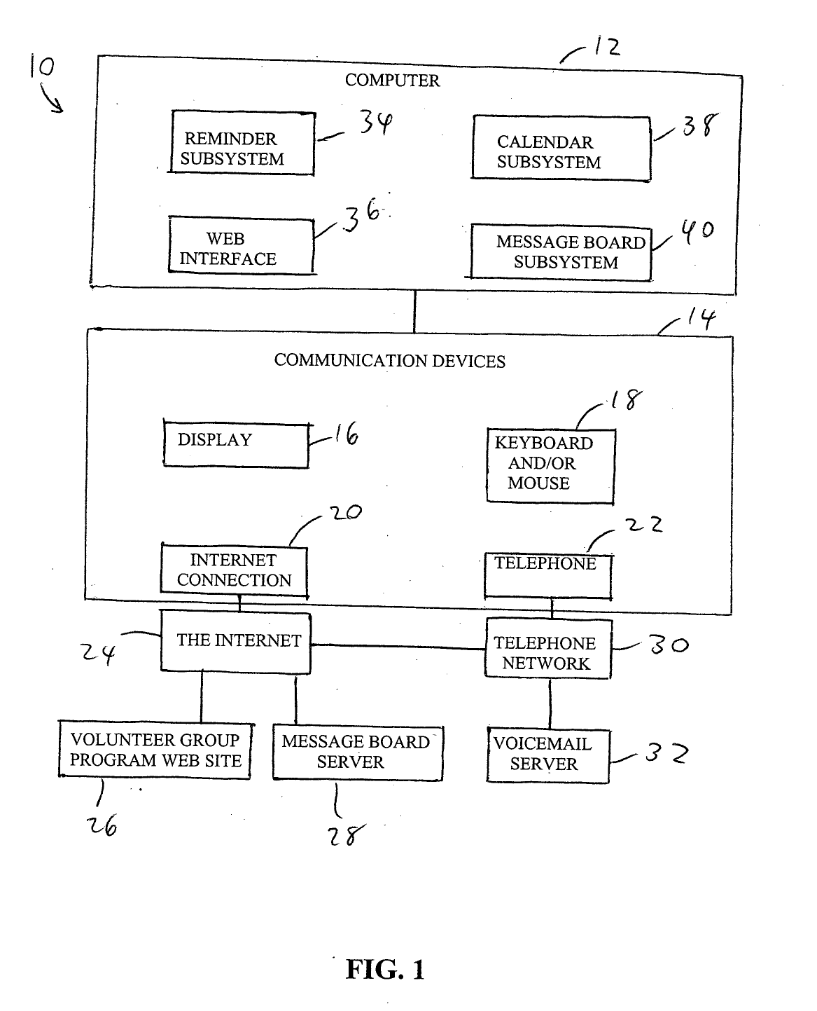

As shown in the representative embodiments illustrated in FIGS. 1-5, the method and system of the present invention provides for recruiting participants and organizing and managing a volunteer team to perform a volunteer group program. The system is computer-based and presents a menu of possible goals for the volunteer group program. In response to user input, the system generates an electronic organizational framework with specific roles, responsibilities and sub-systems needed to achieve the stated goals.

The system requests contact information for individuals that undertake specific tasks along with information related to the specific preferences regarding ways to achieve volunteer group program goals. The system generates an electronic operational manual for the volunteer group, along with appropriate tools for enlisting additional volunteer contributions and for managing their efforts. Tools may include a Web site, an automated telephone system, or other mechanisms for discussion, scheduling of services, and communication of program goals and status, as well as providing reminders to individual volunteers of pending tasks associated with the program.

The system of the present invention not only facilitates the assembly of the team to conduct the volunteer group program, but also provides specific guidance for determining the goals of the team, the tasks that need to be completed to achieve the team's goals and the appropriate timing for completion of the tasks. As shown in FIG. 1, the system 10 includes a computer 12 connected to communication devices 14 including input and/or output devices or mechanisms, such as a display 16, a keyboard and/or a mouse 18, a telecommunication and/or Internet connection 20, and a telephone 22, for use by the user to interact through the computer 12 to external devices and systems to contribute to the volunteer program initiated and managed by the present invention.

As used herein, the terms Internet and web shall also be understood to include local area networks, or LANS, such as are operated by businesses, or other organizations. Use of the invention can be limited to employees or members of the sponsoring entity.

The Internet connection 20 allows the user to interact, through the Internet 24, with a volunteer group program Web site 26 associated with a given volunteer group program and/or team assisting in achieving the volunteer group program goals. Through the Internet 24, the user can also interact with a message board server 28 to access and post text and other forms of messages, such as audio and/or video associated with the volunteer group program.

The telephone 22 allows the user to interact, through a telephone network 30, such as a public switched telephone network (PSTN), to access a voicemail server 32 to access and post audio messages such as voicemail or recordings associated with the volunteer group program. The telephone 22 can be provided in addition to, or instead of, the Internet connection 20, for example, if the user does not have or cannot access the Internet 24. In addition, the telephone 22 can be used with and/or incorporate a modem to connect to the Internet 24 through the telephone network 30.

The computer 12 includes known hardware and software for implementing the present invention, for example, to provide a reminder subsystem 34, a Web interface 36, a calendar subsystem 38, and a message board subsystem 40. The reminder subsystem 34 tracks the tasks and generates reminder messages to the appropriate team members to insure that the tasks are not overlooked. The reminder messages can be sent by known communication means, such as voicemail to the telephones, cellphones or telephone voicemail mailboxes associated with each team member and/or saved on the voicemail server 32; a fax signal to send a facsimile of the reminder message to those team members with facsimile machines; a text message to a team member's cellphone; an electronic mail or E-mail to one or more team members' E-mail accounts via the Internet 24; a pop-up screen text message to a computer display 16 associated with a particular team member; and/or a text message to an electronic bulletin board for viewing by a particular team member or a number of team members. Accordingly, the reminder subsystem 34 is capable of sending automated and/or customized reminders in a broadcast mode or in a team-member specific mode.

The reminder subsystem 34 can also be used to communicate and share, through known communication means including voicemail and/or a specific Web site 26 as described above, the volunteer group program goals with other potential volunteers, enabling them to volunteer to take on other tasks that contribute to the achievement of the overall volunteer group program goals.

The Web interface 36 is included to allow access to the Web site 26 stored on a computer server connected to the World Wide Web and accessible through the Internet 24, to provide information to users accessing the Web site 26 associated with the volunteer group program. The Web interface 36 of the computer system 10 can include known Internet browsers or Internet access technology, including software operating on personal computers and/or webphones. When a user uses the Web interface 36, the computer system 10 generates and displays the Web site 26. The Web interface 36 can use known authentication systems, as described herein, to control and protect access to the Web site of the computer system 10 and/or of the associated volunteer group program.

The calendar subsystem 38 provides information on specific dates for which volunteer efforts are needed to complete predetermined tasks, and publicizes the work of volunteers up to a predetermined date.

The message board subsystem 40 manages the posting and viewing of messages to the message board server 28, which stores and maintains an electronic message board or bulletin board, which enables the user that has been granted access to the Web site or voicemail server, through the computer system 10, to publish information as well as statements of encouragement to the team and the Program Subject, the individual or group which the team supports in performing the volunteer group program. The message board subsystem 40 can be used in conjunction with the Web interface 36 for the viewing of messages on the message board through the Internet 24. The message board subsystem 40 can also be used in conjunction with the reminder subsystem 34 for posting voicemail messages stored on the voicemail server 32 and made accessible to users via the telephone 22.

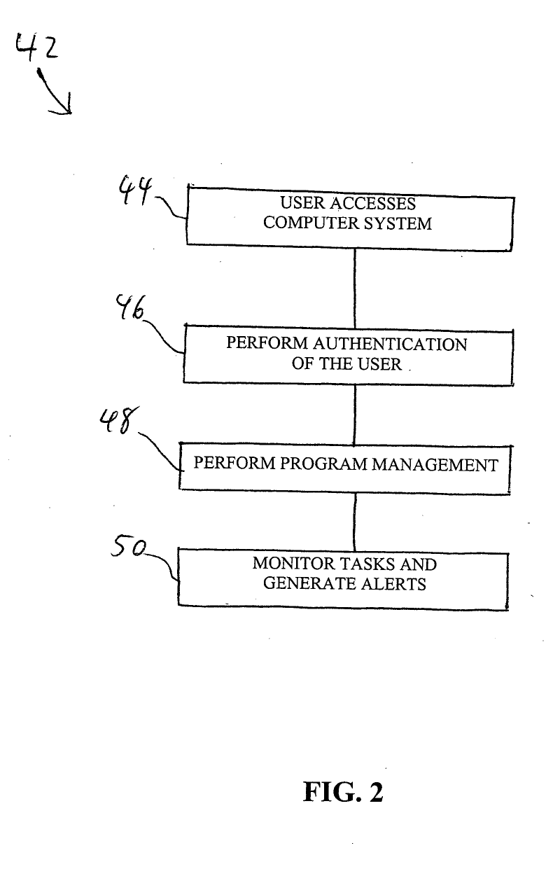

The method 42 of the present invention is implemented by the computer system 10 using a software program which operates the steps shown in FIG. 2, in which the user accesses system 44 of the computer system 10; performs an authentication step 46; performs a program management step 48; and performs task monitoring and alert generation 50.

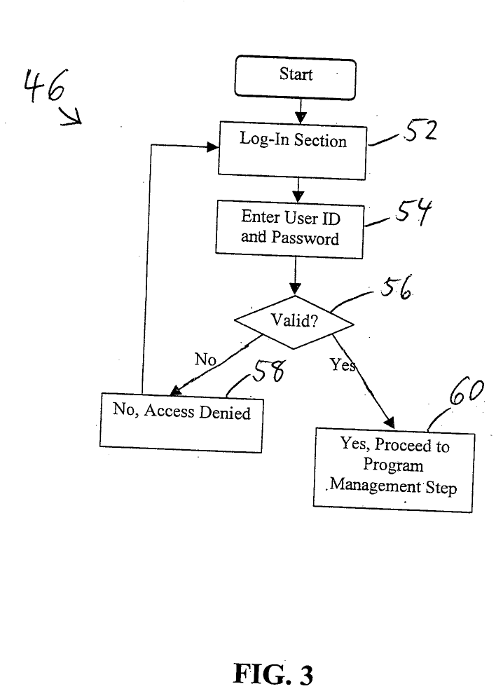

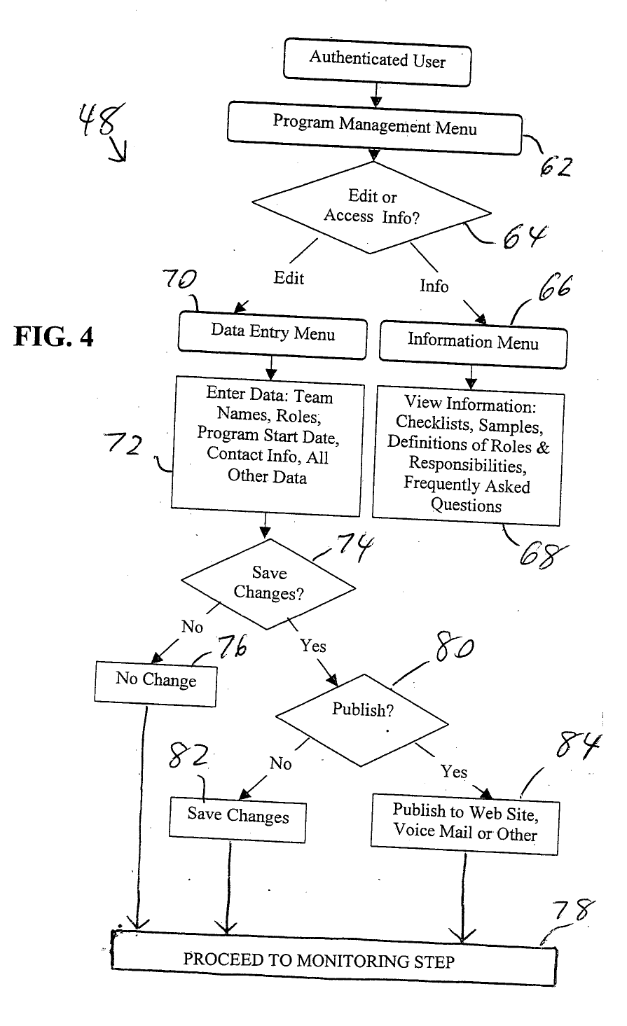

Referring to FIG. 3, the authentication step 46 starts by providing the user of the computer system 10 with a display screen or window on the display 16 with a login section 52 with fields or input lines allowing the user to enter a user identification (ID) and/or a password via the keyboard and/or mouse 18. The user enters data for the user ID and/or password 54, and the computer system 10 checks 56 to determine if the entered data is valid. If not, access is denied 58, and the method loops back to display the login screen 52. If a valid user ID and/or password is entered, the process proceeds 60 to perform the program management step 48, as shown in FIG. 4.

Referring to FIG. 4, in performing step 48 the program management step, the method displays a program management menu 62 to the user via the display 16 to choose 64 whether to edit existing information or enter new information into the computer system 10 regarding a given volunteer group program, or merely to access and view the existing information without modification. If the user chooses 64 to access information, the system displays an information menu 66, and the user can view screen 68 with information such as checklists, samples, definitions of roles and responsibilities of team members of the volunteer group program and frequently asked questions.

If the user chooses 64 to edit information regarding a given volunteer group program, a data entry menu is displayed 70 providing fields or input lines allowing the user to enter 72 data or otherwise to edit existing data, such as team names and their roles, a program start date, contact information of the team members, completed tasks, and all other data pertinent for managing and conducting the volunteer group program.

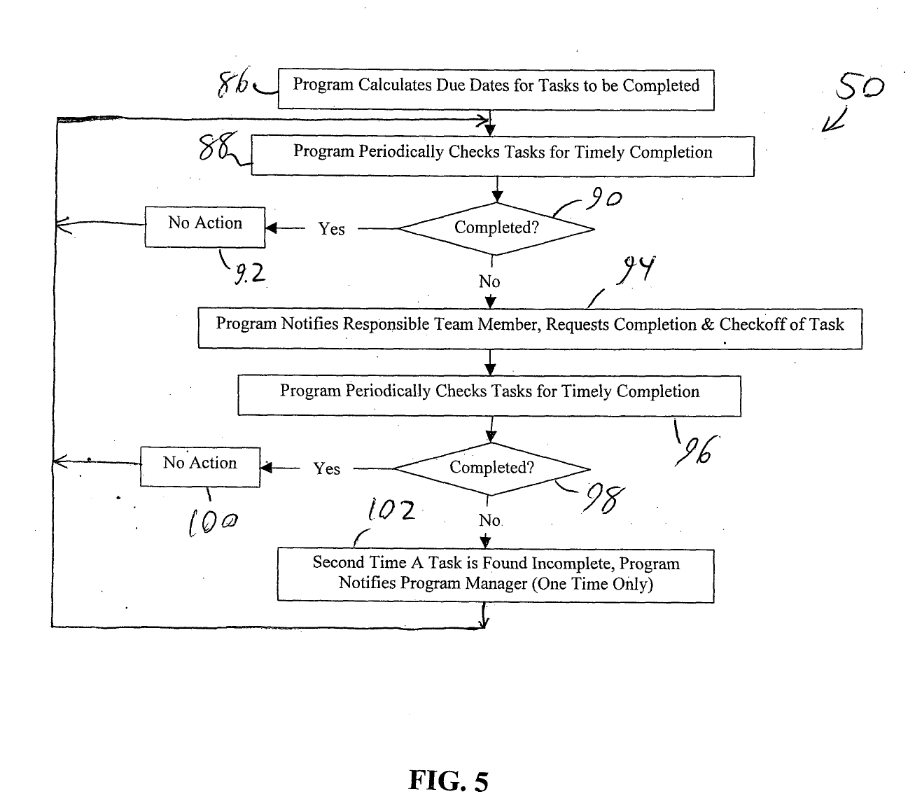

After the user has entered the data 72, the user has a choice of whether or not to save 74 the newly entered data and/or any changes to existing data. If the user chooses not to save the changes, no change is performed 76, and the method proceeds 78 to monitor 50 tasks, as shown in FIG. 5. However, if the user chooses 74 to save the changes, the user is presented 80 with the further choice of whether or not to publish the changes. For example, the changes or data entry can require review by other team members before being published.

Therefore, if the user chooses to not publish the changes 80, the changes are saved 82, and the method proceeds 78 to monitor 50 tasks. However, if the user chooses to publish the changes 80, the method publishes 84 the changes to an appropriate communication mechanism, such as the Web site 26 associated with the volunteer group program, voice mailboxes of team members on a voicemail server 32, the electronic bulletin board maintained by the message board subsystem 40, or other known publication means. In addition, the information can be saved for archival purposes, as described herein. After publication 84, the method proceeds 78 to monitor 50 tasks.

As shown in FIG. 5, the steps of task monitoring 50 and alert generation performed by the method including the steps of calculating 86 due dates for tasks to be completed, periodically checking 88 tasks for timely completion, and determining 90 if a given task is completed. If so, no action is taken 92, and the method loops back to check 88 other tasks.

However, if a given task is determined 90 to not have been timely completed, the method notifies 94 and alerts the responsible team member of the situation, and requests completion and check off of the task. The method then periodically checks 96 those tasks for completion for which an alert was previously sent 94. If the method determines 98 if the previously alerted task has been completed, the method takes 100 no action, and the method loops back to continue 88 checking tasks.

However, if the previously alerted task has been found 98 for a second time to be incomplete, the method notifies 102 a Program Manager, one time only, that a previously alerted task remains incomplete. The method then loops back to continue 88 checking tasks to periodically monitor and track the completion of tasks to fulfill the volunteer group program.

In use, the system 10 and method 42 of FIGS. 1-5 can be implemented and accessed in a first embodiment using an Internet-based configuration. In a second embodiment, the system 10 and method 42 of FIGS. 1-5 can also or alternatively be implemented and accessed using a telephone-based configuration, suited for users who do not have Internet access to volunteer group programs.

In the first embodiment with an Internet-based configuration for access and use, the user is presented with the authentication step in FIG. 3, and following successful authentication, is prompted to enter or edit data that will identify the goals of the volunteer group program supported by the system 10, as shown in FIG. 4. The user is then asked if the information should be saved or published. If saved, the information is stored in memory on a computer server of the computer 10 for access at another time. If published, the information is saved to a database on the computer server, such as the message board server 28 or a web server storing the Web site 26, for example, for archival purposes.

The system 10 organizes the data within templates that can be presented via a browser to the general public over the Internet 24. Several types of information are collected and published, including but not limited to: text description of the goals of the volunteer group program; the nature, details, and history of the needs of the individual or group which the volunteer group program seeks to support; calendar entries, including dates, times, and descriptions of time-sensitive needs such as transportation or meals, and the names of volunteers who have committed to fulfilling specific instances of those needs; photographs of interested parties; video recordings of interested parties; sound recordings of interested parties; and audio, visual, and/or text-based guest book entries, including messages from site visitors as well as messages to site visitors from the individual or group which the volunteer group program and/or the Web site 26 supports. Such information can be stored in the message board server 28.

In the second embodiment with a telephone-based configuration for access and use, the user is presented with the authentication step in FIG. 3, and following successful authentication, is prompted to enter or speak data that will identify the goals of the volunteer group program supported by the system 10, as shown in FIG. 4. The user is then asked if the information should be saved or published. If saved, the information is stored on a voicemail server 32 for access at another time. If published, the information is saved to a database on a voicemail server 32, for example, for archival purposes.

The system 10 organizes the data so that the data can be accessed through telephone keypad commands entered through a telephone keypad of the telephone 22. Several types of information are collected and published, including but not limited to: verbal descriptions of the goals of the volunteer group program; the nature, details, and history of the needs of the Program Subject, the individual or group which the volunteer group program seeks to support; calendar entries, including dates, times, and descriptions of time-sensitive needs such as transportation or meals, and the names of volunteers who have committed to fulfilling specific instances of those needs; sound recordings of interested parties; and oral guest book entries, including audio messages from site visitors as well as messages to system visitors from the Program Subject, the individual or group which the volunteer group program and/or the system 10 supports.

The system 10 and method 42 can be used initially by the volunteer group program's Program Manager: that is, a director, administrator, or originator who sets up a volunteer group program through the program management step 48 shown in FIG. 4, and in particular, steps 70-74. The Program Manager, using the system 10 and method 42, creates the volunteer group program to provide the information menu of possible program goals to the Program Subject through the computer system 10; provides a process to the Program Subject through the computer system 10 for facilitating their decisions on which of the possible program goals to pursue; generates and outputs electronically, from the computer system 10, an organizational framework based on the decided goals, with specific roles, responsibilities, and features needed to achieve the decided goals; provides tools for recruiting additional volunteers, managing and scheduling the efforts of the additional volunteers, and communicating details related to progress of the volunteer group program to all interested parties; provides an option to the Program Manager to set a requirement of password access to control access of others to the Web site 26 accessible through the computer system 10; provides project timelines, procedures, content guidelines, examples, and editable copy from the computer system for use by the additional volunteers; and provides promotional materials generated by the computer system 10, such as through steps 80-84 of FIG. 4, to build awareness of the volunteer group program among potential new volunteers.

Once the volunteer group program is set up by the Program Manager, subsequent users of the system 10 and method 42 can access the established volunteer group program via an information menu in steps 66-68 of FIG. 4.

The method and system of the invention provides small groups of inexperienced volunteers with the information and a structured process to easily and efficiently initiate and manage a specific project. The project can be helping an individual, a family, or other small group in circumstances that have a temporary or permanently disruptive effect on their personal lives. Such circumstances can include, but are not limited to, physical limitations or disabilities resulting from accidents or disease, birth of a baby, a financial setback, the need to care for an elderly relative, or fulfillment of a responsibility that breaks an individual's existing links to informal support networks, such as military service, attending school away from home, or a business assignment out of town or overseas. The structured program of the invention identifies the specific needs of a Program Subject and to convert the good intentions of friends, relatives, neighbors, and co-workers into specific assistance and actions to meet those needs. Two examples of how the invention would work follow:

The following examples are illustrative of embodiments of the invention. As will be apparent to those of ordinary skill in the art from the above description and these examples, numerous variations and changes can be made to adapt the system and method of the invention to a variety of circumstances involving the needs of individuals and groups.

### EXAMPLE A

In this example, “Subject A” is diagnosed with a serious disease that will require her to take time off from work and travel to a distant location for treatment. Subject A will suffer a loss of income, and this loss could be compounded by increased expenses associated with travel for treatments, medical costs not covered by insurance, and the costs of services required to compensate for her inability to fulfill certain responsibilities (laundry, lawn care, housecleaning, transporting children to school and activities, pet care, etc.). Her spouse can take on additional responsibilities, but he must also care for her and accompany her to distant locations for treatment. They receive many requests for information and non-specific offers of help from well-meaning friends, but lack the time necessary to respond to each offer.

When Subject A informs her employer of her health problem, the employer, a “customer”, having access to the system of the invention provides Subject A with authentication information that allows her to access the present invention over a local area network (LAN), sponsored by the employer, via the Internet, or by telephone. The employer also provides her with an information sheet that includes a suggestion that she ask a close friend (ideally not a “caregiver”) to initiate the program for her. Subject A then provides the authentication information and information sheet to a close friend who has agreed to become a “manager,” specifically, the “Program Manager,” for Subject A's participation in system of the invention.

The Program Manager, who is comfortable using a computer, uses his home PC and his Internet access to view the general information Web site associated with the present invention. After entering the authentication information, the Program Manager accesses the invention's program management section. This section provides, among other features, a diagnostic questionnaire that asks a number of questions that need to be answered by the Subject A and her caregiver spouse. In this case, the Program Manager prints out a copy of the questionnaire, meets with Subject A and her caregiver, and obtains specific information regarding their situation, including some details on her illness, areas of need that have resulted from the new demands placed on them, a name they would be comfortable using for the program (i.e. “Friends of Subject A”), and anything they would like to communicate to the community at large. He also optionally requests photos that can be scanned and converted to electronic image files for publishing on the program's Web site.

The Program Manager then enters the information provided in response to the questions into the program management section of the invention, which then establishes the goals of the program. Based on these goals, the software system of the invention generates a list of roles or tasks that need to be assumed by volunteers, the overall responsibilities associated with each role, examples of written work and activities that can simplify accomplishment of the responsibilities, specific tasks that need to be completed and a suggested time table or schedule. The system generates a checklist for each role, which the responsible manager can access to check off tasks as they are completed. The invention sends email reminders to the responsible manager if tasks remain uncompleted past a predetermined date, and notifies the Program Manager if the task remains uncompleted at a further predetermined time.

The invention also provides significant information on how to build awareness of the program within the community, and places an electronic order for business cards to be sent to the Program Manager. These business cards can be used by all the managers working on the program, and are distributed during daily activities to build awareness and communicate the address of the Web site. By providing this structure, both during the start up of the program, as well as during the life of the program, the invention dramatically reduces the effort required of the volunteer managers, and insures that the program produced will be comprehensive, efficient, and effective. It allows the volunteer managers to support the Program Subject, the work that matters most to them, and frees them from the need to create a program from the ground up.

In one preferred embodiment, the Web site includes four standard program elements, and can optionally include other sections that are based on the program's objectives.

A first standard element is an update section, which appears on the Web site home page, the first page that site visitors see. The update section provides text information on the Program Subject's current situation. This section is updated regularly and whenever there is significant news to report. When updated information is added, the text of the update it replaces is added to an archive that is accessible by a hyperlink at the end of the update section. Also appearing on the home page are links to all of the other site sections, as well as information on how to contact each of the managers involved in the project.

The second standard element is a guest book where site visitors can enter messages of encouragement, ideas, or even information for general viewing. Managers, or even the Program Subject, can leave messages there as well, and it can serve as a bulletin board or vehicle for thank-you or greeting messages from them. Subject A can use it for a daily update, to provide visitors with current information and avoid having to respond to multiple well-meaning, but possibly disruptive and undesired phone calls.

The third standard element is the calendar that includes the upcoming time-sensitive needs of Subject A and her caregiver, as well as past contributions, at a level of detail that is determined while completing the diagnostic questionnaire. The program provides the option to note past contributions as “meal donated,” for example, or “meal donated by the Smiths.” The calendar lists the needs, and provides access by hyperlink navigation to details on the need and how to sign up to deliver (usually by contacting the manager responsible for meal deliveries). Needs can be anything from household chores, to transportation, to pet care, etc. Their common characteristic is time sensitivity, unlike other needs that can be included in other elements of the Web site.

The fourth standard element is the “How You Can Help” section. This section provides a general summary of the areas of need identified by the Program Subject and caregiver, and directs potential volunteers to specific areas of the Web site to sign up to donate services, products, or other types of physical or emotional support. It's greatest value is to first-time visitors, because it helps them understand how to participate in the program and use the Web site.

One optional element is a meal delivery section. While the calendar lists days and types of meals needed (breakfast, lunch, etc.), the meal delivery section provides detail on food restrictions, delivery procedures (knock/don't knock, etc.), suggested restaurants for those who are donating from out of town or not cooking meals themselves, and other information. To minimize miscommunication, meal donators can be directed by programmed prompts or a designated pathway to communicate their intent to the volunteer who has taken on the food manager role. Notification of confirmed donation dates and times can be done by phone, email, face-to-face communication or other means. The food manager reviews any relevant information with the volunteer, assigns them a date/time, and enters the appropriate information in the calendar section of the program. The food manager also notifies the meal donors shortly before their meal delivery date to remind them of their commitment. Because the Web site is usually publicly accessible, this step insures that all offers of assistance are bona fide, and not a prank. Optionally, the program can permit direct entry of meal donation commitments by volunteer donators.

Another optional element is a grocery delivery section, which functions similarly to the meal delivery section described above.

A third optional element is a household support section, which also functions similarly to the meal/grocery delivery sections for time-sensitive tasks such as transportation, but also posts time-flexible tasks such as yard work or videotape rental pick ups/drop offs on the household support page on the “Friends of Subject A” Web site. For example a volunteer can offer to pick up Subject A's sister at the airport at a specified time and date via e-mail or phone call to the service manager, meeting the flight based on the information posted in the calendar entries for that day, and also donate their time to rake leaves at Subject A's home anytime that week.

A fourth optional element is a photo section where photos can be published. Subject A's volunteer team could choose some older photos of her, showing the fun of her childhood, and mix them with some photos that show the effects of the disease. Although not flattering, Subject A has found that it reduces the looks of surprise that she gets when she visits friends or meets a co-worker unexpectedly. Including photos of friends, some of which include Subject A in joyful situations, adds an optimism to this section, and can generate interest in repeat visits.

A fifth optional element is the gift registry where Subject A, her caregiver and close family members, can list items that would be helpful to them in their current situation. Subject A, for example, could identify an oscillating fan to keep her comfortable, while her spouse/caregiver might identify an air purifier. They have also identified books on tape, since Subject A is having trouble with her vision, and a reclining chair, so her spouse/caregiver can rest or sleep while staying close by.

A sixth optional program element is identified as “Donate”. This is a section where Subject A's financial need can be stated. During the review of the diagnostic questionnaire with the project manager, Subject A disclosed details of the financial burden she was facing. While few people feel comfortable offering or accepting donations without extreme need, the present invention offers Subject A an opportunity to share her financial concerns in a less direct way, and for the community around her to provide financial assistance, with clear understanding of Subject A's need. Other users of this invention may choose to direct funds to a charity, religious organization, or other group. It is their option, and is uncovered during the diagnostic questionnaire review. The mechanism for collecting funds can be in the form of checks, cash, or the volunteer team can decide to set up a credit card donation option.

A seventh optional element can be entitled “Thoughts and Prayers” and is offered to Subject A during the review of the diagnostic questionnaire. It provides an opportunity to give guidance to the community on how Subject A would like to be supported spiritually. Because she does not belong to any specific religious group, she has requested general prayers and good wishes be made with her in mind. Because she selected the Thoughts and Prayers section, one of her managers has been given the task of identifying appropriate organizations where her intentions can be considered, and prayed for. Hyperlinks to Web sites of other organizations can be set up on the Thoughts and Prayers page, and visitors to Subject A's Web site can use these links to visit and request prayers or meditations with the intent of providing Subject A with spiritual comfort.

An eighth optional area of the system of the invention can be identified as “Thank You”. This area is used for Subject A to express appreciation to the general community that has supported her, or specific individuals that have provided exceptional support. If Subject A is uncomfortable singling out specific donors because she has received several large anonymous donations, she can use this section to express a thank you to the entire community. Other Program Subjects may choose to provide specific details on donations received.

In this instance, because Subject A, her caregiver, and the Program Manager knew the community could utilize computers and the Internet, they choose to have the invention generate a Web site, using the program name and other information provided, populate it with the information the Program Manager has entered, and, at the Program Manager's discretion, publish it to the World Wide Web, using an address based on the program name. Alternatively, this information can be published via a telephone-based system, which we will discuss in the second example presented here.

In accordance with the preferred embodiment described, Subject A will have the four standard elements at her supporting Web site. Because she has many needs, she will be using all of the optional sections as well. However, since the system of the invention has divided the responsibilities and provided each manager with guidance on how to accomplish his or her tasks, the team needed to support this program can be as few as 3 or 4 friends working ten hours per week on clearly allocated tasks that can be accommodated in the volunteers' own personal schedules.

As will be known to those of ordinary skill in the art, highly sophisticated voice recognition and voice synthesis system exist for use with telephone systems. Examples include transportation schedules, arrival information; business directories of all types; appliance and telephone warranty and repair services and the like. These prior art systems are computer directed and readily adapted for use with the present invention.

### EXAMPLE B

In this example, “Subject B” received injuries that will require him to take time off from work. Subject B will suffer a loss of income, and this loss could be compounded by the costs of services required to compensate for his inability to fulfill certain responsibilities (painting, lawn care, transporting children to school and activities, pet care, etc.). His spouse can take on additional responsibilities, but she must also care for him and accompany him to doctor's offices for treatment. They receive many requests for information and non-specific offers of help from well-meaning friends, but lack the time necessary to respond to each offer.

When Subject B informs his employer of his injury and recovery prognosis, the employer, a “customer”, having access to the present invention provides him with authentication information that will allow him to access the program via the employer's server. The employer also provides him with an information sheet that includes a suggestion that he ask a close friend (ideally not a “caregiver”) to initiate the program for him. Subject B then provides the authentication information and information sheet to a close friend and co-worker who has agreed (with the employer's consent) to become a “manager,” specifically, the “Program Manager,” for Subject B's participation in the invention.

Because he is not adept at using a computer, the Program Manager dials the phone number provided on the information sheet and enters his authentication information via the telephone keypad to access the program management function of the invention, and requests copies of the information he needs to start up the program that will be developed by the invention. He will be sent, along with other information about the program, a diagnostic questionnaire that asks a number of questions that need to be answered by the Program Subject and his caregiver. In this case, the Program Manager brings the questionnaire to a meeting with Subject B and his caregiver, and obtains information regarding their situation, including some details on Subject B's injury and prognosis for recovery, some areas of need that have resulted from the new demands placed on them, a name they would be comfortable using for the program (e.g. “Friends of Subject B”), and any other information that they would like to communicate to the community at large.

The Program Manager then uses his telephone to access the program management section of the invention, and enters the answers to the questions in the diagnostic questionnaire, which provides the invention with the goals of the program. The answers are entered using telephone keypad entries in response to a number of prompts (press one if you would like a Thank You section included in your telephone support site). Based on these goals, the present invention generates, and mails to the Program Manager, a list of roles that need to be taken on by volunteers, the overall responsibilities associated with each role, examples of written work and activities that can simplify accomplishment of the responsibilities, specific tasks that need to be completed and a suggested time table.

The program of the invention generates a checklist for each role, which the responsible manager can access over the phone to check off tasks as they are completed. For example, the first week's tasks included sending an announcement of the program to the local newspapers. When this has been completed, please press one. The invention phones in pre-recorded reminders to the responsible manager if tasks remain incomplete past a certain date, and phones the Program Manager with a pre-recorded reminder if the task remains incomplete at a certain point after that. The invention also arranges for delivery of a large amount of information on how to build awareness of the program in the community, and places an electronic order for business cards to be sent to the Program Manager. These business cards are used by all the managers working on the program, and are handed out during daily activities to co-workers and others to build awareness and communicate the phone number of the telephone support site.

Because Subject B, his caregiver, and the Program Manager believe their community could also be uncomfortable with computers and the Internet, they choose to have the invention generate a telephone support site, using the program name and other information provided, populate it with the information the Program Manager has entered, and, at the Program Manager's discretion, make it accessible to callers. Information can also be included on a Web site in addition to the phone site for volunteers and others who find using the employer's LAN or the Internet more convenient.

The telephone support site also includes four standard elements described above, and can include other optional elements based on the program's objectives and the Program Subject's needs and desires.

Upon dialing into the telephone support site, a caller hears the main menu: “Welcome to Subject B's telephone support site. You can return to this menu at any time by pressing the star key on your keypad, or by saying ‘main menu’.

The first standard element is an update section: “If you would like to listen to updates on Subject B, please press or say ‘One’ now”. This is the first item mentioned upon connecting to the telephone support site's main menu. If it is selected, the caller has additional choices: “If you would like to hear the latest update, July 1^{st} at 1 PM, please press or say ‘One’ now”. If callers choose this option, they are provided with a short message giving an update on the status of the subject. This section is updated regularly by the responsible volunteer manager, and whenever there is significant news to report. When an update is entered into the system, the update it replaces is added to an archive that is accessible by a second option “If you would like to hear all previous updates, starting with the most recent, please press or say ‘Two’ now. If you would like to hear all previous updates, starting with the oldest, please press or say ‘Three’ now”.

The second standard element is a guest book: “If you would like to leave or listen to guest book messages, please press or say ‘Two’ now” where site visitors can record messages of encouragement, ideas, or even information for general listening: “To record a message, please press or say ‘One’ now”. Managers, or even the Program Subject, can leave messages there as well, and it can serve as a vehicle for thank-yous or hello's from them. Subject B often uses it as a daily update, giving visitors a quick insight into his frame of mind without having to field multiple, well-meaning, but interruptive phone calls. Callers are offered a second option: “If you would like to listen to the past five guest book messages, please press or say ‘Two’ now”.

The third standard element is the Calendar. This provides information on upcoming time-sensitive needs of Subject B and his caregiver, at a level of detail that is determined while completing the diagnostic questionnaire. Some may choose to note upcoming contributions as “meal donated,” for example, while others may choose to say “meal donated by the Smiths.” The caller can select a date, or a range of dates or times and the system will speak the needs, and provide access phone touchpad navigation to details on the need and how to sign up to deliver: “If you'd like more information on this giving opportunity, please press or say ‘One,’ or if you'd like to hear about the next opportunity, please press or say “Two,” or if you'd like to hear about the previous opportunity, please press or say ‘Three.’” Needs posted on the calendar can be anything from household chores, to transportation, to pet care, etc. Their common characteristic is time sensitivity, unlike other needs that may be addressed in other sections of the phone support site.

The fourth standard element is the “How You Can Help” section. This section provides a general summary of the areas of need identified by the subject and caregiver, and directs potential volunteers to specific areas of the Web site to sign up to donate services, products, or other types of physical or emotional support: “If you would like to volunteer to deliver a meal, please press or say ‘One’ to select a date from the calendar, or press or say “Two” or to leave a message and you will be contacted with potential dates.”. It's greatest value is to first-time visitors, because it helps them understand how to participate in the program and use the telephone support site.

In addition to the four standard elements on his telephone support site described above, Subject B will elect all of the optional elements. Since the optional elements are entirely comparable to those described in connection with the Internet embodiment of Example 1, limited specific telephone responses are provided below.

In a first optional element, a meal delivery section recites days and types of meals needed (breakfast, lunch, etc.), the meal delivery section recites detail on food restrictions, delivery procedures (knock/don't knock, etc.), suggested restaurants for those who are donating from out of town or not cooking meals themselves, and other information. Meal donors can enter their planned donation directly into the calendar, or be directed to communicate their intent to the volunteer who has taken on the food manager role. Notification can be done by phone, e-mail, face-to-face communication or other means. The food manager can review any relevant information with the volunteer, assigns them a date/time, and make the appropriate voice message entry in the calendar. The food manager also calls the meal donors shortly before their meal delivery date to remind them of their commitment. However, the program can optionally allow individual donors to sign up at the telephone support site for particular meals and dates directly, by selecting the date/time and recording their name and phone number when prompted. Where the subject will require this assistance over a long period of time and a known group of volunteers have an established routine of performance, the direct entry will be adopted.

A second optional element is a grocery delivery section, which functions substantially the same as the meal delivery section.

A third optional element is a household support section, which also functions substantially identically to the meal/grocery delivery sections for time-sensitive tasks such as those described in Example A, above.

A fourth optional element, which Subject B will be using, is the Gift Registry. This subsystem provides a means for the responsible volunteer manager to dial up, and using a password or other coded entry, gain access to a portion of the telephone system for recording a request for items that would be helpful to Subject B, his caregiver, and close family members, if desired, in their current situation. Each individual, in addition to the subject can be given a different password or coded identification to gain entry. Similarly, potential donators are encouraged to leave voice messages informing the responsible manager of his or her intent to purchase a specific gift, so the manager can revise the list at the telephone support site.

A fifth optional element is identified on the call-in menu as Donate and functions in a manner similar to the Gift Registry. This element is described in the Internet embodiment, with the exception that the voice message can be that of the subject or of another identified or anonymous participant who explains his financial concerns. Funds can be solicited in the form of checks or cash or a credit card donation option can be provided for entry of data by the telephone keypad in response to prompts.

A the sixth optional element, Thoughts and Prayers, provides an opportunity for either the subject to personally in his own voice give guidance to the community on how he would like them to support him spiritually, or to designate one of his managers or even a religious leader in his community to identify appropriate organizations where his intentions can be considered and prayed for. Phone numbers for contacting these organizations will be available in this section (“If you'd like the phone number for the Ethical Culture Society, please press or say ‘One’ now”), and visitors to Subject B's telephone support site can use these numbers to contact organizations and request prayers or meditations with the intent of providing Subject B spiritual comfort.

A seventh element to the telephone-based program is identified as Thank You. This element is used by Subject B to express personal appreciation to the general community that has supported him, or to mention specific individuals that have provided exceptional support. Spoken lists of new (past week) donations or previous donations are made accessible here to callers. He also uses this element to express a personalized voice mail thank you to the entire community for their supporting efforts.

As noted above, the telephone-based system is computer controlled and directs callers to enter data into the system audibly and/or by use of the caller's telephone keypad. As will be apparent to one of ordinary skill in the art, voice recognition programs can convert words recorded into digital data that can also be entered in an electronic database similar to data typed and transmitted via e-mail as described in Example A, above. Thus, a system and method can be established that can be used by telephone callers and by computer users who gain access via a LAN or the Internet. In this embodiment, data entered digitally is converted by a voice synthesizer program into a voice message. Alternatively, a Program Manager with computer skills and program access can periodically review electronic data inputs and herself dial into the telephone system to record the corresponding analog voice message.

From the foregoing, it will be appreciated that, although specific embodiments of the invention have been described herein for purposes of illustration, various modifications may be made without deviating from the spirit and scope of the invention. These modifications would be apparent to those skilled in the art.

1. A method in a computer system for initiating and managing a volunteer group program that includes a plurality of volunteers, the method comprising:
providing an information menu of predetermined program goals to a user of the computer system;
providing an interactive process to the user through the computer system to enable the user to select at least one of the program goals on the menu to pursue;
generating and outputting electronically, from the computer system, an organizational framework based on the at least one selected goal, with specific roles, responsibilities, and features needed to achieve the at least one selected goal;
providing tools for:
recruiting additional volunteers;
managing and scheduling the efforts of the additional volunteers; and
communicating details related to progress of the volunteer group program to all interested parties;
providing an option to the user to set a requirement of password access to control access of others to a World Wide Web site associated with the volunteer group program and accessible through the computer system;
providing project timelines, procedures, content guidelines, examples, and editable copy from the computer system for use by the additional volunteers; and
providing promotional materials generated by the computer system to build awareness of the volunteer group program among potential new volunteers.

2. The method of claim 1, wherein the tools are provided for use through the World Wide Web site accessible through the computer system.

3. The method of claim 1, wherein access to the tools are provided by telephone means.

4. The method of claim 1, wherein the managing and scheduling of the efforts of the additional volunteers includes:
periodically checking selected tasks for timely completion; and
transmitting to a responsible volunteer team member a request for completion of a non-completed task.

5. The method of claim 4, wherein the managing and scheduling further comprises:
periodically checking previously posted and selected tasks for timely completion; and
transmitting to the responsible volunteer a second request for completion of any non-completed task.

6. The method of claim 1, further comprising:
providing a computer system reminder sub-routine to track tasks of the volunteer group program, and to generate and send reminder messages to responsible volunteers via communication means to insure that the tasks are not overlooked.

7. The method of claim 1, further comprising:
providing a calendar subsystem of the computer system to list information on specific dates for which volunteer efforts are needed, and to publicize the work of volunteers up to a given date.

8. The method of claim 1, further comprising:
providing the computer system with a message board management system to manage the posting and viewing of messages to a message board server connected to the computer system which stores and maintains an electronic message board to enable users to publish information and statements of encouragement to the team and the individual or group which the team supports in performing the volunteer group program.

9. The method of claim 1, further comprising:
providing a World Wide Web or private network interface of the computer system to allow access to a Web site associated with the volunteer group program to provide information to Web site visitors regarding the volunteer group program.

10. The method of claim 1, further comprising:
providing Internet-based access to computer system for Internet users with Internet access; and
providing telephone-based access to the computer system for telephone users without Internet access.

11. A computer-based system for initiating and managing a volunteer group program, comprising:
at least one communication device; and
a computer connected to the communication device and including:
means for providing an information menu of possible program goals to the user;
means for providing a process to the user for facilitating the user to decide on which of the possible program goals to pursue;
means for generating and outputting electronically an organizational framework based on the decided goals, with specific roles, responsibilities, and features needed to achieve the decided goals;
means for providing tools for recruiting additional volunteers, managing and scheduling the efforts of the additional volunteers, and communicating details related to progress of the volunteer group program to all interested parties;
means for providing an option to the user to set a requirement of password access to control access of others to a Web site associated with the volunteer group program;
means for providing project timelines, procedures, content guidelines, examples, and editable copy from the computer system for use by the additional volunteers; and
means for providing promotional materials generated by the computer system to build awareness of the volunteer group program among potential new volunteers.

12. The computer-based system of claim 11, wherein the means for providing tools includes:
means for accessing the tools through the World Wide Web site.

13. The computer-based system of claim 11, wherein the means for providing tools includes:
means for accessing the tools through a telephone.

14. The computer-based system of claim 11, wherein the means for managing and scheduling of the efforts of the additional volunteers includes:
means for periodically checking tasks for timely completion; and
means for notifying a responsible team member to request completion of non-completed tasks.

15. The computer-based system of claim 11, wherein the means for managing and scheduling further comprises:
means for periodically checking previously notified tasks for timely completion; and
means for notifying the responsible team member a second time to request completion of non-completed tasks.

16. The computer-based system of claim 11, further comprising:
a reminder subsystem of the computer system to track tasks of the volunteer group program, and to generate and send reminder messages via a communication mechanism to appropriate team members to insure that the tasks are not overlooked.

17. The computer-based system of claim 11, further comprising:
a calendar subsystem of the computer system to list information on specific dates for which volunteer efforts are needed, and to publicize the work of volunteers up to a given date.

18. The computer-based system of claim 11, further comprising:
a message board subsystem of the computer system to manage the posting and viewing of messages to a message board server connected to the computer system which stores and maintains an electronic message board to enable users to publish information and statements of encouragement to the team and the individual or group which the team supports in performing the volunteer group program.

19. The computer-based system of claim 11, further comprising:
a World Wide Web interface of the computer system to allow access to a Web site associated with the volunteer group program to provide information to users regarding the volunteer group program.

20. The computer-based system of claim 11, further comprising:
means for providing Internet-based access to computer system for Internet users with Internet access; and
means for providing telephone-based access to the computer system for telephone users without Internet access.
